(19) United States
(12) Patent Application Publication
(10) Pub. No.: US 2010/0027995 A1
(43) Pub. Date: Feb. 4, 2010

(54) GANGED OPTICAL SWITCH

(75) Inventor: Kevin Stuart FARLEY, Ottawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: NORTEL NETWORKS LIMITED, St. Laurent (CA)

(21) Appl. No.: 12/183,839

(22) Filed: Jul. 31, 2008

(51) Int. Cl. H04J 14/00; G02B 6/28

(52) U.S. Cl. 398/49; 385/24

(57) ABSTRACT

A ganged optical switch comprising at least one wavelength selective ganged optical switching element, first and second sets of input ports, and first and second sets of output ports. Optical signals entering one of the first set of input ports can be routed, in a first routing, via the at least one ganged optical switching element to one of the second set of output ports, and optical signals entering one of the first set of input ports can be routed, in a second routing, via the at least one ganged optical switching element to one of the second set of output ports. The ganged optical switching element ensures that the first and second routings are interdependent. In one embodiment, some of the output ports are shared between the first and second sets of output ports. ROADMs and protection switching applications of the ganged optical switches of the invention are also disclosed.

### CROSS REFERENCE TO RELATED APPLICATIONS

This application is related to the following applications: U.S. application Ser. No. 12/183,851 (Attorney Docket No.: PAT 5203-2) entitled “Optical Roundabout Switch” and filed of even date herewith, which is incorporated herein by reference in its entirety.

### FIELD OF THE INVENTION

The present invention relates generally to optical switching. More particularly, the present invention relates to novel means of reducing the number of components required to implement optical switching systems.

### BACKGROUND OF THE INVENTION

Reconfigurable optical add-drop multiplexers (ROADMs) significantly enhance the flexibility of long-haul, regional and metropolitan optical networks. Because they enable remote reconfiguration of traffic at the wavelength-level, ROADMs allow service providers to avoid truck rolls and expensive manual configuration of network nodes. Consequently, there is a significant economic benefit to deploying ROADMs.

ROADMs can be constructed using a broadcast and select architecture, as illustrated in FIG. 1. The ROADM of FIG. 1 comprises two 2×1 wavelength selective switch multiplexers 10, two 1×2 splitter demultiplexers 20, and four passive multiplexer/demultiplexer filters 30, 32, 34 and 36. Each of multiplexers TX-WEST 32 and TX-EAST 36, and demultiplexers RX-WEST 30 and RX-EAST 34 comprises a passive filter, which has the advantage of being inexpensive, but the disadvantage of not being tunable.

A tunable ROADM can be constructed according to the arrangement shown in FIG. 2. Wavelength selective switch (WSS) modules 40 and 44 add tunability to the receiving end of the ROADM, while WSS modules 10 provide tunability to the transmitting ends of the ROADM. Disadvantageously, transmission-side splitters 42 and 46 introduce high losses, which, when coupled with the losses typically found in WSS modules 10, can lead to significant losses when adding signals using the ROADM of FIG. 2. A further disadvantage of the ROADM shown in FIG. 2 is that the use of four WSS modules can be uneconomical, given the high cost of these modules.

One means of avoiding the high losses inherent in the ROADM shown in FIG. 2 is to directly attach WSS modules to the transmit and receive ends of the ROADM, as shown in FIG. 3. Although the elimination of the splitters 42 and 46 of FIG. 2 significantly reduces losses when adding signals, the individual WSS multiplexer modules 50 required to implement an ROADM as shown in FIG. 3 are significantly more expensive than the simpler 2×1 WSS multiplexer modules 10 used in FIG. 2, because of their higher port count.

It is, therefore, desirable to provide an economical means of implementing a tunable ROADM without using a large number of WSS modules and without incurring high losses.

### SUMMARY OF THE INVENTION

It is an object of the present invention to obviate or mitigate at least one disadvantage of previous optical switching components.

In a first aspect, the present invention provides a ganged optical switch including at least one wavelength selective ganged optical switching element having at least two possible states. The ganged optical switch has a first set of input ports and a first set of output ports, and the at least one wavelength selective ganged optical switching element determines a first routing of optical signals between at least one input port of the first set of input ports and at least one output port of the first set of output ports. The ganged optical switch has a second set of input ports and a second set of output ports, and the at least one wavelength selective ganged optical switching element determining a second routing of optical signals between at least one input port of the second set of input ports and at least one output port of the second set of output ports. The at least one wavelength selective ganged optical switching element tying said first routing and second routing such that a change of state of the at least one wavelength selective ganged optical switching element state produces a change in both said first and second routings.

In an embodiment, at least one of the sets of input ports and output ports includes a plurality of ports. In another embodiment, at least one of the output ports is a member of the first set of output ports and a member of the second set of output ports. In yet another embodiment, no output port in the first set of output ports is a member of the second set of output ports. In still yet another embodiment, at least one port is in optical communication with the at least one wavelength selective ganged optical switching element via an optical circulator. In a still further embodiment, a passive multiplexing filter is provided having an output port in optical communication with at least one member of the first set of input ports and the second set of input ports. In a still further embodiment, a tunable multiplexing filter is provided having an output port in optical communication with at least one member of the first set of input ports and the second set of input ports. In a still further embodiment, a passive demultiplexing filter is provided having an input port in optical communication with at least one member of the first set of output ports and the second set of output ports. In a still further embodiment, a tunable demultiplexing filter is provided having an input port in optical communication with at least one member of the first set of output ports and the second set of output ports. In a yet still further embodiment, an optical performance monitoring module is provided, in optical communication with at least one member of the first set of output ports and the second set of output ports.

In a second aspect of the present invention, a ROADM is provided including a first ganged optical switch, which includes a first ganged optical switch's at least one wavelength selective ganged optical switching element having at least two possible states, a first ganged optical switch's first set of input ports and a first ganged optical switch's first set of output ports, a first ganged optical switch's second set of input ports and a first ganged optical switch's second set of output ports. The first ganged optical switch's at least one ganged optical switching element determines a first ganged optical switch's first routing of optical signals between at least one input port of the first ganged optical switch's first set of input ports and at least one output port of the first ganged optical switch's first set of output ports. The second ganged optical switch's at least one wavelength selective ganged optical switching element determines a first ganged optical switch's second routing of optical signals between at least one input port of the first ganged optical switch's second set of input ports and at least one output port of the first ganged optical switch's second set of output ports. The first ganged optical switch's at least one wavelength selective ganged optical switching element ties said first ganged optical switch's first routing and said first ganged optical switch's second routing such that a change of state of the first ganged optical switch's at least one ganged optical switching element state produces a change in both said first ganged optical switch's first routing and said first ganged optical switch's second routing.

In an embodiment, the ROADM also includes a second ganged optical switch, which includes a second ganged optical switch's at least one wavelength selective ganged optical switching element having at least two possible states, a second ganged optical switch's first set of input ports and a second ganged optical switch's first set of output ports; a second ganged optical switch's second set of input ports and a second ganged optical switch's second set of output ports. The second ganged optical switch's at least one ganged optical switching element determines a second ganged optical switch's first routing of optical signals between at least one input port of the second ganged optical switch's first set of input ports and at least one output port of the second ganged optical switch's first set of output ports. The second ganged optical switch's at least one wavelength selective ganged optical switching element determines a second ganged optical switch's second routing of optical signals between at least one input port of the second ganged optical switch's second set of input ports and at least one output port of the second ganged optical switch's second set of output ports. The second ganged optical switch's at least one wavelength selective ganged optical switching element ties said second ganged optical switch's first routing and second ganged optical switch's second routing such that a change of state of the second ganged optical switch's at least one ganged optical switching element state produces a change in both said second ganged optical switch's first routing and second ganged optical switch's second routing.

In an embodiment, the ROADM also includes a first optical waveguide connecting a first direction express-out port of the of the first ganged optical switch's second set of output ports with a second direction express-in port of the second ganged optical switch's first set of input ports, a second optical waveguide connecting a second direction express-out port of the second ganged optical switch's second set of output ports with a first direction express-in port of the first ganged optical switch's first set of input ports, and a ROADM controller for controlling the wavelength selective ganged optical switching elements of each of the first and second ganged optical switches. The first ganged optical switch's first set of input ports includes a first direction add port, the first ganged optical switch's first set of output ports includes a first direction transmit port, the first ganged optical switch's second set of input ports includes a first direction receive port, and the first ganged optical switch's second set of output ports also includes a first direction drop port. The second ganged optical switch's first set of input ports also includes a second direction add port, the second ganged optical switch's first set of output ports also includes a second direction transmit port, the second ganged optical switch's second set of input ports includes a second direction receive port, and the second ganged optical switch's second set of output ports also includes a second direction drop port. The ROADM controller has an add/drop ROADM state wherein the ROADM controller causes the at least one wavelength selective ganged optical switching element of the first ganged optical switch to place the first direction add port in optical communication with the first direction transmit port and the second direction receive port in optical communication with the second direction drop port, and wherein the ROADM controller causes the at least one wavelength selective ganged optical switching element of the second ganged optical switch to place the second direction add port in optical communication with the second direction transmit port and the first direction receive port in optical communication with the first direction drop port. The ROADM controller also has an express ROADM state wherein the ROADM controller causes the at least one wavelength selective ganged optical switching element of the first ganged optical switch to place the first direction express-in port in optical communication with the first direction transmit port and the first direction receive port in optical communication with the first direction express-out port, and wherein the ROADM controller causes the at least one wavelength selective ganged optical switching element of the second ganged optical switch to place the second direction express-in port in optical communication with the second direction transmit port and to place the second direction receive port in optical communication with the second direction express-out port.

In an embodiment, the first ganged optical switch's first set of input ports includes a first direction add port and a second direction receive port, the first ganged optical switch's first set of output ports includes a second direction drop port and a first direction transmit port, the first ganged optical switch's second set of input ports includes a second direction add port and a first direction receive port, and the first ganged optical switch's second set of output ports includes a second direction transmit port and a first direction drop port. The first ganged optical switch's at least one wavelength selective ganged optical switching element has an add/drop ROADM state which places the first direction add port in optical communication with the first direction transmit port, the first direction receive port in optical communication with the first direction drop port, the second direction add port in optical communication with the second direction transmit port, and the second direction receive port in optical communication with the second direction drop port. The first ganged optical switch's at least one wavelength selective ganged optical switching element also has an express ROADM state which places the first direction receive port in optical communication with the second direction transmit port, and the second direction receive port in optical communication with the first direction transmit port.

In an embodiment, a ROADM is provided which also includes a ROADM controller for controlling the at least one wavelength selective ganged optical switching element of each of the first and second ganged optical switches. One of the first ganged optical switch's first set of input ports is a first direction add port, one of the first ganged optical switch's second set of input ports is a second direction receive port, one of the first ganged optical switch's first set of output ports is a first direction dump port, one of the first ganged optical switch's second set of output ports is a second direction drop port, and a first direction transmit port belongs to both the first ganged optical switch's first set of outputs and the first ganged optical switch's second set of outputs. One of the second ganged optical switch's first set of input ports is a second direction add port, one of the second ganged optical switch's second set of input ports is a first direction receive port, one of the second ganged optical switch's first set of output ports is a second direction transmit port, one of the second ganged optical switch's second set of output ports is a first direction drop port, and a second direction transmit port belongs to both the second ganged optical switch's first set of outputs and the second ganged optical switch's second set of outputs. The ROADM controller can enter an add/drop ROADM state wherein the ROADM controller causes the at least one wavelength selective ganged optical switching element of the first ganged optical switch to place the first direction add port in optical communication with the first direction transmit port and the second direction receive port in optical communication with the second direction drop port, and wherein the ROADM controller causes the at least one wavelength selective ganged optical switching element of the second ganged optical switch to place the second direction add port in optical communication with the second direction transmit port and the first direction receive port in optical communication with the first direction drop port. The ROADM controller can enter an express ROADM state wherein the ROADM controller causes the at least one wavelength selective ganged optical switching element of the first ganged optical switch to place the first direction add port in optical communication with the first direction dump port and the second direction receive port in optical communication with the first direction transmit port, and wherein the ROADM controller causes the at least one wavelength selective ganged optical switching element of the second ganged optical switch to place the second direction add port in optical communication with the second direction dump port and to place the first direction receive port in optical communication with the second direction transmit port.

In an embodiment, a ROADM is provided wherein the first ganged optical switch's first set of input ports includes a second direction express-in port and a second direction add port, the first ganged optical switch's first set of output ports includes a second direction transmit port, the first ganged optical switch's second set of input ports includes a first direction express-in port and a first direction add port and the first ganged optical switch's second set of output ports includes a first direction transmit port.

In an embodiment, a ROADM is provided wherein the first ganged optical switch's first set of input ports includes a second direction receive port, the first ganged optical switch's first set of output ports includes a second direction drop port and a second direction express-out, the first ganged optical switch's second set of input ports includes a first direction receive port, and the first ganged optical switch's second set of output ports includes a first direction drop port and a first direction express-out port. The first ganged optical switch is a multiplexing ganged optical switch.

In an embodiment, a ROADM is provided which also includes a first optical waveguide connecting a first direction express-out port of the of the second ganged optical switch's second set of output ports with a second direction express-in port of the first ganged optical switch's first set of input ports, a second optical waveguide connecting a second direction express-out port of the second ganged optical switch's first set of output ports with a first direction express-in port of the first ganged optical switch's second set of input ports, and a ROADM controller for controlling the wavelength selective ganged optical switching elements of each of the first and second ganged optical switches. The first ganged optical switch's first set of input ports includes the second direction express-in port and a second direction add port, the first ganged optical switch's first set of output ports includes a second direction transmit port, the first ganged optical switch's second set of input ports includes the first direction express-in port and a first direction add port, and the first ganged optical switch's second set of output ports includes a first direction transmit port. The second ganged optical switch's first set of input ports includes a second direction receive port, the second ganged optical switch's first set of output ports includes a second direction drop port and a second direction express-out, the second ganged optical switch's second set of input ports includes a first direction receive port, and the second ganged optical switch's second set of output ports includes a first direction drop port and a first direction express-out port. The ROADM controller can enter an add/drop ROADM state wherein the ROADM controller causes the at least one wavelength selective ganged optical switching element of the first ganged optical switch to place the second direction add port in optical communication with the second direction transmit port and the first direction add port in optical communication with the first direction transmit port, and wherein the ROADM controller causes the at least one wavelength selective ganged optical switching element of the second ganged optical switch to place the second direction receive port in optical communication with the second direction drop port and the first direction receive port in optical communication with the first direction drop port. The ROADM controller can also enter an express ROADM state wherein the ROADM controller causes the at least one wavelength selective ganged optical switching element of the first ganged optical switch to place the second direction express-in port in optical communication with the second direction transmit port and the first direction express-in port in optical communication with the first direction transmit port, and wherein the ROADM controller causes the at least one wavelength selective ganged optical switching element of the second ganged optical switch to place the second direction receive port in optical communication with the second direction express-out port and to place the first direction receive port in optical communication with the first direction express-out port.

In an embodiment, a ROADM is provided which also includes a first splitter having a first splitter's first direction receive port, a first splitter's first output port and a first splitter's second output port, a second splitter having a second splitter's second direction receive port, a second splitter's first output port and a second splitter's second output port; a first optical waveguide connecting the first splitter's first output port with a second direction express-in port of the second ganged optical switch's first set of input ports, a second optical waveguide connecting the first splitter's second output port with a first direction receive port of the first ganged optical switch's second set of input ports, a third optical waveguide connecting the second splitter's first output port with a first direction express-in port of the first ganged optical switch's first set of input ports, a fourth optical waveguide connecting the second splitter's second output port with a second direction receive port of the second ganged optical switch's second set of input ports, and a ROADM controller for controlling the wavelength selective ganged optical switching elements of each of the first and second ganged optical switches. The first ganged optical switch's first set of input ports also includes a first direction add port, the first ganged optical switch's first set of output ports includes a first direction transmit port, and the first ganged optical switch's second set of output ports also includes a first direction drop port. The second ganged optical switch's first set of input ports also includes a second direction add port, the second ganged optical switch's first set of output ports also includes a second direction transmit port, and the second ganged optical switch's second set of output ports also includes a second direction drop port. The ROADM controller has an add/drop ROADM state wherein the ROADM controller causes the at least one wavelength selective ganged optical switching element of the first ganged optical switch to place the first direction add port in optical communication with the first direction transmit port and the second direction receive port in optical communication with the second direction drop port, and wherein the ROADM controller causes the at least one wavelength selective ganged optical switching element of the second ganged optical switch to place the second direction add port in optical communication with the second direction transmit port and the first direction receive port in optical communication with the first direction drop port. The ROADM controller has an express ROADM state wherein the ROADM controller causes the at least one wavelength selective ganged optical switching element of the first ganged optical switch to place the first direction express-in port in optical communication with the first direction transmit port, and wherein the ROADM controller causes the at least one wavelength selective ganged optical switching element of the second ganged optical switch to place the second direction express-in port in optical communication with the second direction transmit port.

In a third aspect, the present invention provides a protection switching element including a ganged optical switch which includes at least one wavelength selective wavelength selective ganged optical switching element having at least two possible states, first set of input ports and a first set of output ports, and a second set of input ports and a second set of output ports. The at least one ganged optical switching element determines a first routing of optical signals between at least one input port of the first set of input ports and at least one output port of the first set of output ports. The at least one wavelength selective ganged optical switching element determining a second routing of optical signals between at least one input port of the second set of input ports and at least one output port of the second set of output ports. The at least one wavelength selective ganged optical switching element ties said first routing and second routing such that a change of state of the at least one ganged optical switching element state produces a change in both said first and second routings. The first set of input ports includes a receive port, the first set of output ports includes a protection receive port and a working receive port; the second set of input ports includes a protection transmit port and a working transmit port, and the second set of output ports includes a transmit port.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating a known ROADM system constructed using a broadcast and select architecture;

FIG. 2 is a block diagram illustrating a known tunable ROADM system constructed using a broadcast and select architecture and four WSS modules;

FIG. 3 is a block diagram illustrating a known tunable ROADM system constructed using four direct-attach WSS modules;

FIG. 4A is a conceptual illustration of a (1+4)×(4+1) non-overlapping ganged optical switch according to an embodiment of the present invention;

FIG. 4B is a conceptual illustration of a (1+4)×(4+1) non-overlapping ganged optical switch according to an embodiment of the present invention;

FIG. 5 is a illustration of a (1+1)×(4+4) multicasting non-overlapping ganged optical switch constructed using a diffractive steering element as a multicasting switching element according to an embodiment of the present invention;

FIG. 6 is a block diagram illustrating a tunable ROADM system constructed using two direct-attach wavelength-selective GOS modules according to an embodiment of the present invention;

FIG. 7 is a block diagram illustrating a generic ganged optical switch according to an embodiment of the present invention;

FIG. 8 is a block diagram illustrating a side-ganging ROADM system constructed using two GOS modules according to an embodiment of the present invention;

FIG. 9 is a block diagram illustrating a node ganging ROADM system constructed using a single GOS module according to an embodiment of the present invention;

FIG. 10 is a block diagram illustrating a flow ganging ROADM system constructed using two GOS modules according to an embodiment of the present invention;

FIG. 11 is a block diagram illustrating a mux/demux ganging ROADM system constructed using two GOS modules according to an embodiment of the present invention;

FIG. 12 is a block diagram illustrating a ganged optical switch using optical circulators and a single Mach-Zehnder optical switching element according to an embodiment of the present invention; and

FIG. 13 is a block diagram illustrating a protection switching GOS constructed using a single polarization-rotation switching element according to an embodiment of the present invention.

### DETAILED DESCRIPTION

Generally, disclosed herein is a novel ganged optical switch having two interdependent, or ganged, patterns of optical communication, and applications thereof. By providing two interdependent patterns of optical communication, it is possible to construct a ganged optical WSS module capable of performing most of the functions currently performed by two or more WSS modules.

Ganged optical switches (GOSs) can generally be described as having A+B input ports and C+D output ports, where a first routing pattern of optical communication can be established between the A input ports and C output ports via at least one ganged optical switching element, and a second routing pattern of optical communication can be established between the B input ports and D output ports via the at least one optical switching element. In practice, it can be more economical to use a single switching element, but it is equally possible to use a plurality of switching elements so long as they are ganged. In a ganged optical switch, the first and second routing patterns of optical communication are interdependent, meaning that a change to the first pattern of optical communication will affect the second pattern of optical communication, and vice versa. Accordingly, the routing of optical signals between the first set of input ports A and the first set of output ports C is tied to a routing of optical signals between the second set of input ports B and the second set of output ports D by at least one ganged optical switching element.

Generally, the C+D output ports in a ganged optical switch (GOS) are separate, meaning that there is no identity between any of the C output ports and the D output ports; however, certain embodiments of the GOS can be constructed wherein there is some overlap between the C output ports and the D output ports. For the sake of clarity, GOSs having non-overlapping sets of C+D output ports where no member of C is the same as any member of D will be referred to as non-overlapping GOS, and GOSs having overlapping sets of C+D output ports where some members of C are the same as some members of D will be referred to as overlapping GOS. As used herein, the term GOS by itself shall designate both overlapping and non-overlapping GOSs, unless otherwise indicated.

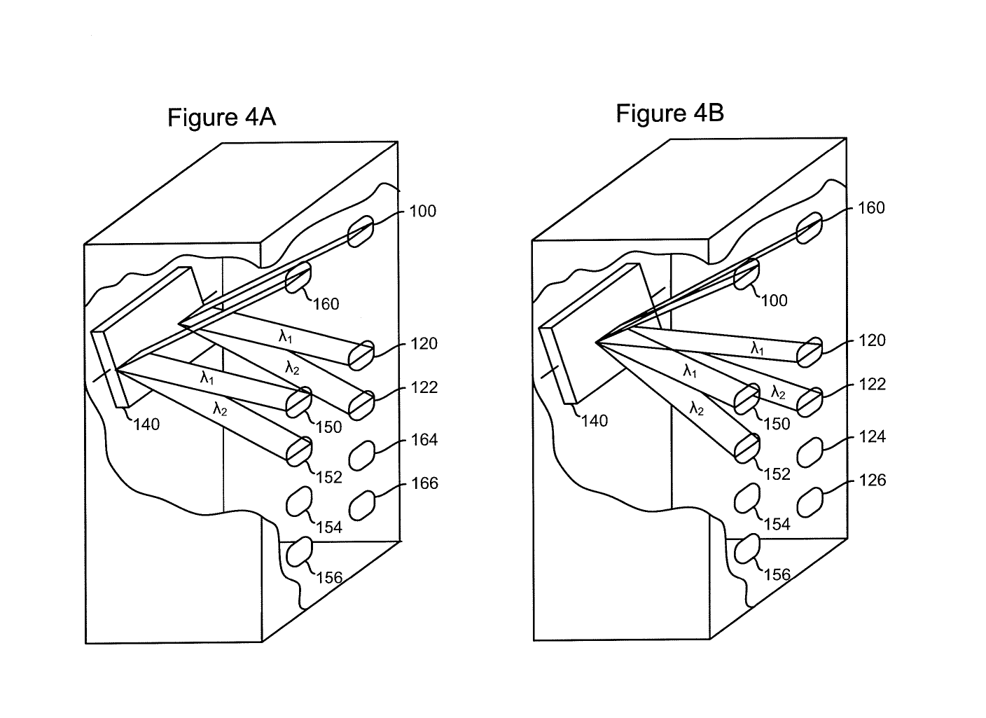

FIGS. 4A-B are conceptual illustrations of (1+4)×(4+1) wavelength-selective non-overlapping ganged optical switches according to two embodiments of the present invention. The exemplary (1+4)×(4+1) non-overlapping ganged optical switches of FIGS. 4A-B comprise the following elements: a first set of input ports comprising input port 100; a second set of input ports 150, 152, 154, 156; a first set of output ports 120, 122, 124 and 126; a second set of output ports comprising output port 160, and an optical switching element 140 comprising a tilting reflective element.

Although exemplary optical switching element 140 is illustrated as a single optical switching element, optical switching element 140 could be replaced with two separate optical switching elements as long as the separate optical switching elements are ganged. As used herein, when used with respect to at least one optical switching elements, the term “ganged” means that the routing of two optical signals between a first set of input ports and a first set of output ports is tied to a routing of optical signals between a second set of input ports and a second set of output ports by the ganged optical switching elements. Accordingly, the exemplary switching element 140 of FIGS. 4A-B may be referred to as a physically ganged optical switching element, since the physical switch itself is a single switch. In an alternative embodiment, the ganged optical switching element comprises two interdependent ganged optical switching elements and may be referred to as a logically ganged optical switching element.

The exemplary ganged optical switches illustrated in FIGS. 4A-B are physically ganged, meaning that light transmitted by the ganged optical switch is reflected off of the same switching element 140. The light can be reflected off of two different portions of the switching element 140 as illustrated in FIG. 4A, or off of the same portion of the switching element 140 as illustrated in FIG. 4B. In the embodiment illustrated in FIG. 4B, the signals end up being horizontally displaced as well as vertically displaced, and that the positions of ports 100 and 160 are different than in FIG. 4A, as a result. The exemplary ganged optical switches of FIGS. 4A-B are wavelength selective, and are illustrate switching signals having wavelengths λ₁ and λ₂. Wavelength λ₁ enters the ganged optical switches of FIGS. 4A-B via input ports 100 and 150, and is redirected by optical switching element 140 to output ports 120 and 160 respectively. Wavelength λ₂ enters the ganged optical switches of FIGS. 4A-B via input ports 100 and 152, and is redirected by optical switching element 140 to output ports 122 and 160 respectively. Such a wavelength selective ganged optical switch can be referred to as a WS-GOS. Although only two wavelengths λ₁ and λ₂ are shown in the exemplary illustrations of FIGS. 4A-B, those of skill in the art will appreciated that a multiplicity of wavelengths may be switched by a WS-GOS.

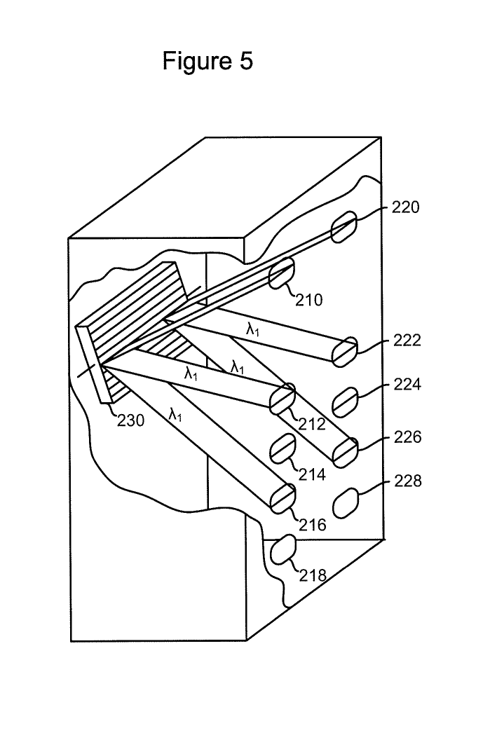

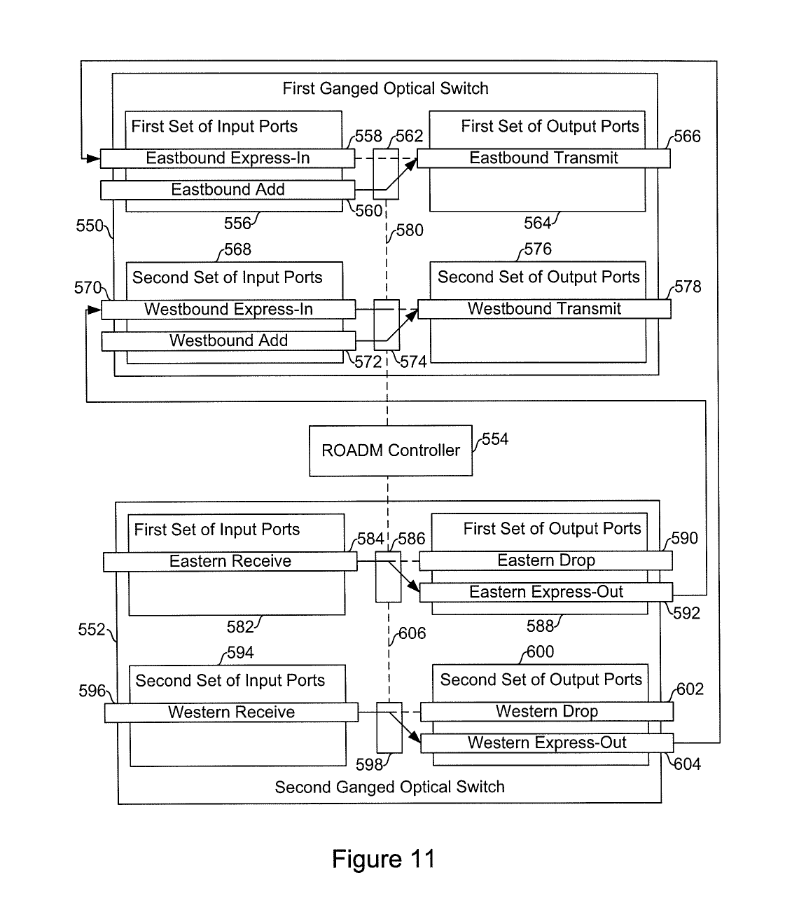

FIG. 5 is a illustration of a (1+1)×(4+4) multicasting non-overlapping ganged optical switch constructed using a diffractive steering element as a multicasting switching element according to an embodiment of the present invention. One exemplary application of such a ganged optical switch would be as the demux-ganging half of a mux/demux ganging ROADM, an exemplary embodiment of which is illustrated in FIG. 11 and described below with reference to that figure. The exemplary (1+1)×(4+4) multicasting non-overlapping ganged optical switches of FIG. 5 comprises the following elements: a first set of input ports comprising input port 210; a second set of input ports comprising input port 220, a first set of output ports comprising output ports 212, 214, 216 and 218; a second set of output ports comprising output ports 222, 224, 226, and 228, and an optical switching element 230 comprising a diffractive steering element. As can be seen from the illustration of FIG. 5, the diffractive steering element 230 can multicast input signals from port 210 to ports 212, and 216, and simultaneously (due to the ganging relationship) multicast input signals from port 220 to ports 222 and 226.

Although the exemplary multicasting non-overlapping ganged optical switch is illustrated as having a diffractive steering element as its ganged switching element 230, those of skill in the art will appreciate that a tilting reflective steering element can also be used, as long as the reflected light beams directed between output ports will be shared between the ports.

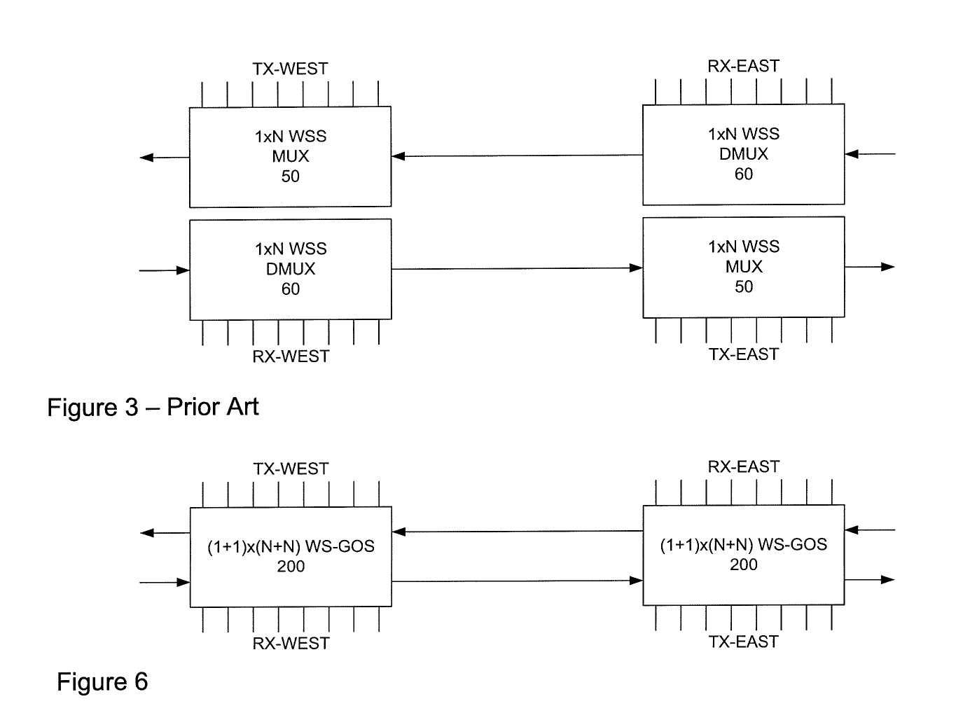

FIG. 6 illustrates an exemplary application of the WS-GOS concept to the construction of a tunable ROADM with low losses. The tunable ROADM is constructed using two WS-GOSs 200, each of which is directly attached to the east and west connections into and out of the ROADM, and each of which has eight inputs for adding signals and eight outputs for dropping signals. Each WS-GOS 200 is also connected to the other WS-GOS 200 to enable the possibility of passing signals through the ROADM. In operation, the ROADM of FIG. 6 differs from the known ROADM of say, FIG. 3, in that the add/drop functionality of each WS-GOS 200 is tied. That is to say, if a signal is added by one side of a given WS-GOS 200, it is also dropped by the other side of that same WS-GOS 200. Accordingly, the independence of both sides of the ROADM is sacrificed in order to achieve significant cost savings by halving the number of WSS modules, relative to the prior art ROADM illustrated in FIG. 3.

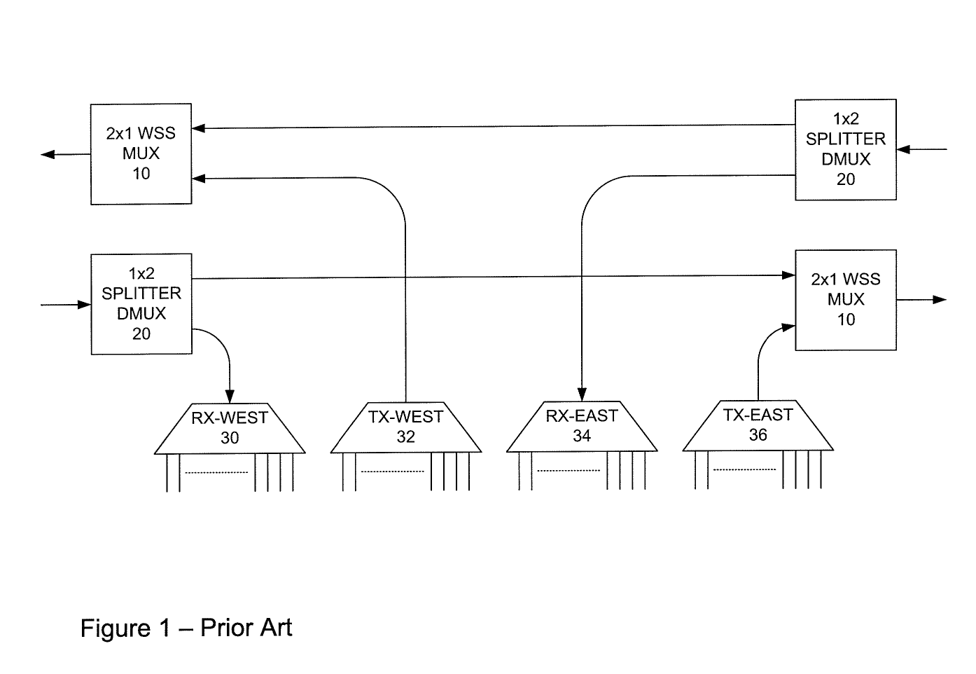

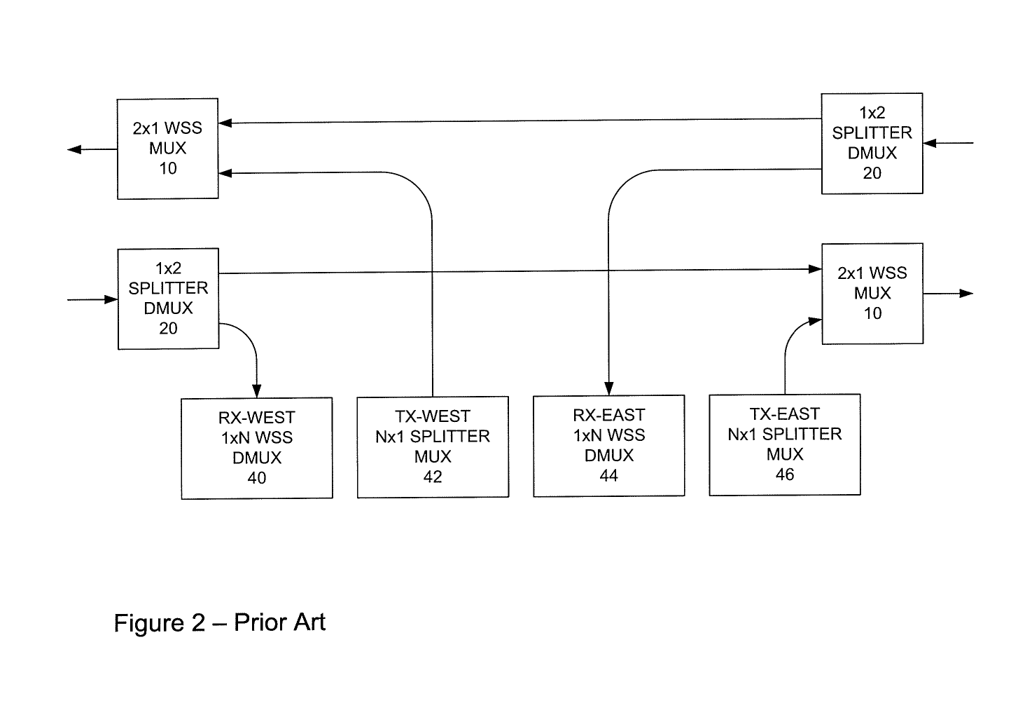

As used herein, the terms east and west are used as examples which can be generalized to arbitrary directions in which external system elements are located with respect to the system under consideration. For example, the east/west directional labels in FIGS. 1-3 and 6 indicate that bidirectional communications (transmit/receive) are available with external elements located to the east and west of the exemplary ROADMs illustrated in those figures. In FIG. 6, for example, the east/west labels indicate bidirectional optical communication (transmit/receive) between an overall ROADM system and other elements in an larger optical network, such as a metro or long-haul optical network. More generally, as used herein, the terms “first direction” and “second direction” are used to indicate arbitrary directions in which equipment external to the system under consideration is located. For example, a first direction can be west, and a second direction can be east. In such an example, a first direction add port is an add port for adding westbound signals, a first direction drop port is a drop port for dropping signals incoming from a western direction, a first direction transmit port is a transmit port for transmitting westbound signals, and a first direction receive port is a receive port for receiving incoming western signals.

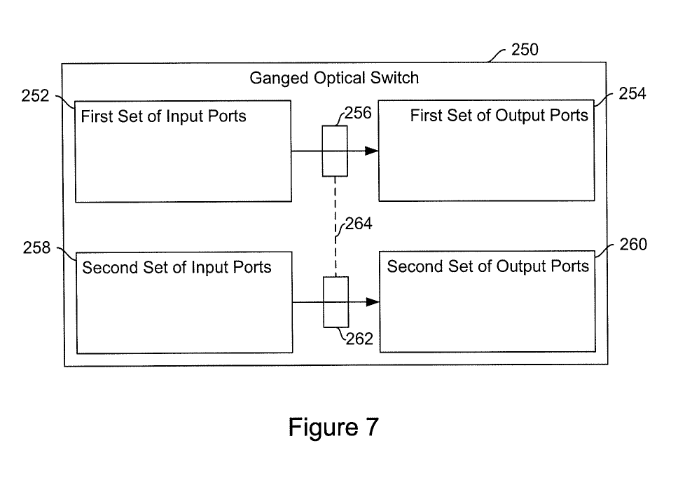

FIG. 7 is a block diagram illustrating a generic ganged optical switch according to an embodiment of the present invention. Ganged optical switch 250 includes a first set of input ports 252, at least one of which is capable of optical communication with at least one of a first set of output ports 254 via a first ganged optical switching element 256. Ganged optical switch 250 also includes a second set of input ports 258, at least one of which is capable of optical communication with at least one of a second set of output ports 260 via a second ganged optical switching element 262. The ganging relationship 264 between first ganged optical switching element 254 and second ganged optical switching element 256 is illustrated conceptually by a dashed line.

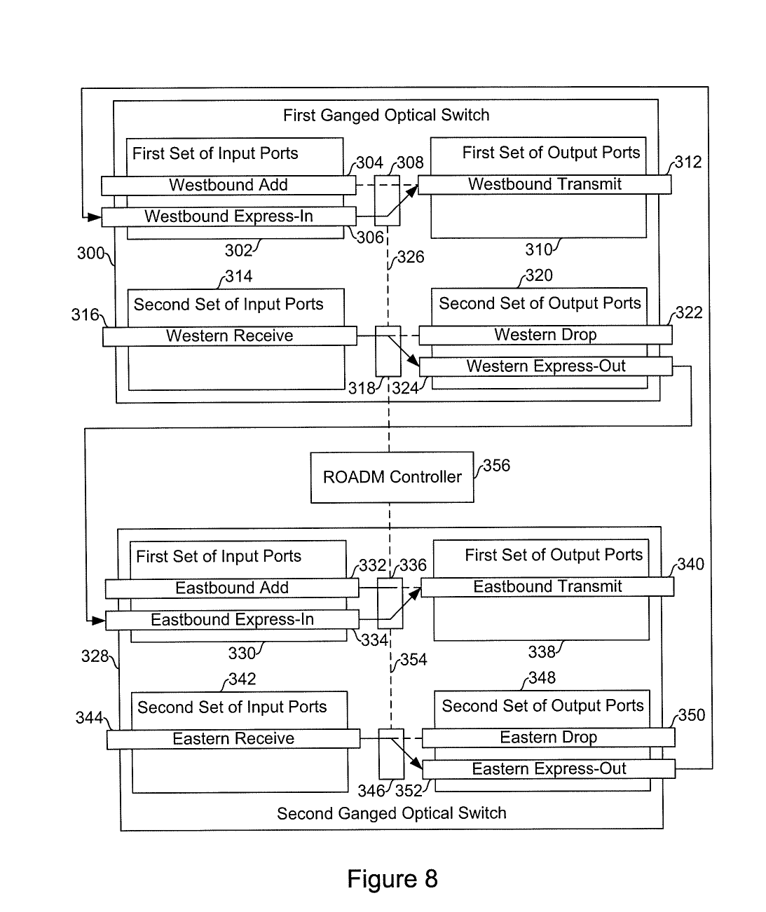

FIG. 8 is a block diagram illustrating a side-ganging ROADM system constructed using two GOS modules according to an embodiment of the present invention. As used herein, the term side-ganging means that each side of the ROADM (e.g. east/west) is a single GOS. An exemplary side-ganging ROADM system comprises a first ganged optical switch 300 a second ganged optical switch 328, and can optionally include a ROADM controller 356 for ganging the two ganged optical switches 300 and 328.

First ganged optical switch 300 comprises a first ganged optical switch's first set of input ports 302, including westbound add port 304 and westbound express-in port 306. Westbound add port 304 and westbound express-in port 306 are in optical communication with the first ganged optical switch's first ganged optical switching element 308. Via the first ganged optical switch's first ganged optical switching element 308, either westbound add port 304 or westbound express-in port 306 can be placed in optical communication with a first ganged optical switch's first set of output ports 310 including westbound transmit port 312. First ganged optical switch 300 further comprises a first ganged optical switch's second set of input ports 314, including a western receive port 316. The western receive port 316 is in optical communication with the first ganged optical switch's second ganged optical switching element 318. Via the first ganged optical switch's second ganged optical switching element 318, the western receive port 316 can be placed in optical communication with at least one output port in the first ganged optical switch's second set of output ports 320, including western drop port 322 and western express-out port 324. The first ganged optical switch's ganging relationship 326 between the first ganged optical switch's first and second ganged optical switching elements, 308 and 318 respectively, is represented by a dashed line.

Second ganged optical switch 328 comprises a second ganged optical switch's first set of input ports 330, including eastbound add port 332 and a eastbound express-in port 334. Eastbound add port 332 and eastbound express-in port 334 are in optical communication with the second ganged optical switch's first ganged optical switching element 336. Via the second ganged optical switch's first ganged optical switching element 336, either eastbound add port 332 or eastbound express-in port 334 can be placed in optical communication with a second ganged optical switch's first set of output ports 338 including eastbound transmit port 340. Second ganged optical switch 328 further comprises a second ganged optical switch's second set of input ports 342, including a eastern receive port 344. The eastern receive port 344 is in optical communication with the second ganged optical switch's second ganged optical switching element 346. Via the second ganged optical switch's second ganged optical switching element 346, the eastern receive port 344 can be placed in optical communication with at least one output port in the second ganged optical switch's second set of output ports 348, including eastern drop port 350 and eastern express-out port 352. The second ganged optical switch's ganging relationship 354 between the second ganged optical switch's first and second ganged optical switching elements, 336 and 346 respectively, is represented by a dashed line. The westbound express-in and eastern express-out ports are in optical communication with each other, and the eastbound express-in and western express-out ports are in optical communication with each other.

Optional ROADM controller 356 can be used to simultaneously control the first ganged optical switch's ganging relationship 326 and the second ganged optical switch's ganging relationship 354. The ROADM controller thereby meta-gangs all four ganged optical switching elements 308, 318, 336, and 346. Indeed the concept can be generalized to any number of ganged optical switches, which can then be meta-ganged into large ROADM networks.

The ROADM controller 356 can enter an add/drop ROADM state, which configures the ganged optical switching elements 308, 318, 336, and 346 such that optical communication between the input and output ports of both ganged optical switches corresponds to the pairings listed in Table 1.

TABLE 1
Add/Drop ROADM State for FIG. 8

| Input port | Output Port |
|---|---|
| Westbound Add 304 | Westbound Transmit 312 |
| Eastbound Add 332 | Eastbound Transmit 340 |
| Western receive 316 | Western drop 322 |
| Eastern receive 344 | Eastern drop 350 |

The ROADM controller 356 can enter an express ROADM state, which configures the ganged optical switching elements 308, 318, 336, and 346 such that optical communication between the input and output ports of both ganged optical switches corresponds to the pairings listed in Table 2.

TABLE 2
Express ROADM State for FIG. 8

| Input port | Output Port |
|---|---|
| Westbound Express-In 306 | Westbound Transmit 312 |
| Eastbound Express-In 334 | Eastbound Transmit 340 |
| Western receive 316 | Western express-Out 324 |
| Eastern receive 344 | Eastern express-out 352 |

Although the exemplary side-ganging ROADM system illustrated in FIG. 8 was described as having non-overlapping GOSs with two logically tied ganged switching elements, it will be appreciated by those of skill in the art that side-ganging ROADM system embodiments can be constructed using overlapping GOSs and/or GOSs with single (e.g. physically tied) switching elements. It should also be appreciated that the switching element(s) can be either wavelength-selective or broadband. Other possible embodiments of the exemplary side-ganging ROADM system illustrated in FIG. 8 can be constructed where only one half of the side-ganging ROADM is constructed using a GOS, and the other half is constructed using prior art WSS modules (e.g. a combination of FIGS. 3 and 6) or a broadcast and select architecture.

In an alternative embodiment of the exemplary side-ganging ROADM illustrated in FIG. 8, two 1×2 splitters can be used to transmit the incoming western and eastern signals to the express-in ports of both ROADMs. For example, one splitter can split the incoming eastern signals and provide them to both the westbound express-in port of the first ganged optical switch and the eastern receive port of the second ganged optical switch, while the other splitter can split the incoming western signals and provide them to both the eastbound express-in port of the second ganged optical switch and the western receive port of the first ganged optical switch. It should be appreciated that some of the connections between both ganged optical switches, such as the express-out connections illustrated in FIG. 8, would not be necessary in such an embodiment. One advantage of this alternative embodiment of the exemplary side-ganging ROADM of FIG. 8 is that, as will be appreciated by those of skill in the art, independent express power control of eastbound and westbound traffic can be achieved using known techniques such as express dynamic gain flattening filters.

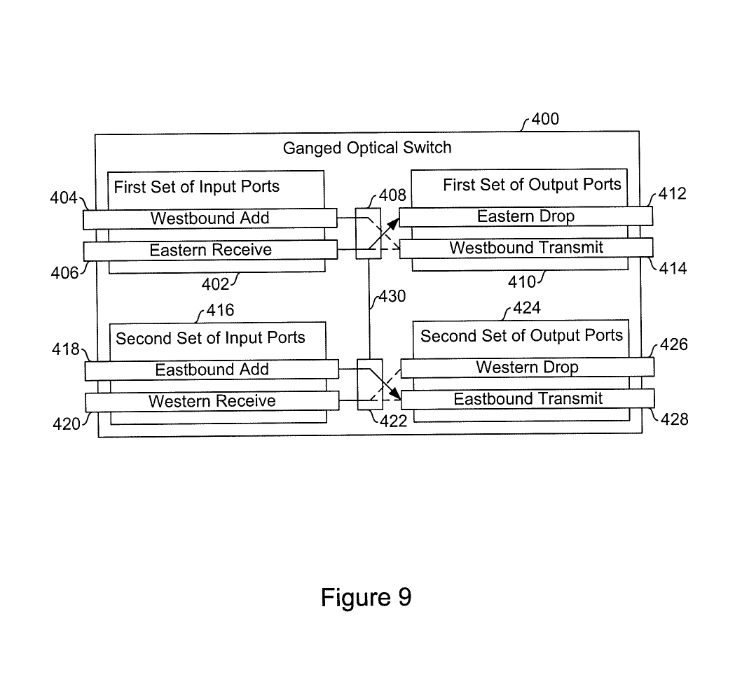

FIG. 9 is a block diagram illustrating a node-ganging ROADM system constructed using a single GOS module according to an embodiment of the present invention. As used herein, the term node-ganging simply means that all ports in the ROADM node are ganged together. An exemplary node-ganging ROADM system comprises ganged optical switch 400, which has a first set of input ports 402 including a eastbound add port 404 and a eastern receive port 406. The eastbound add port 404 and eastern receive port are in optical communication with first ganged optical switching element 408. First ganged optical switching element 408 is configurable such that it can place eastbound add port 404 in optical communication with at least one of a first set of output ports 410 including either a eastern drop port 412 or a westbound transmit port 414. First ganged optical switching element 408 is also configurable such that it can place eastern receive port 406 in optical communication with at least one of a first set of output ports 410 including either a eastern drop port 412 or a westbound transmit port 414.

Ganged optical switch 400 has a second set of input ports 416 including a westbound add port 418 and a western receive port 420. The westbound add port 418 and western receive port are in optical communication with second ganged optical switching element 422. Second ganged optical switching element 422 is configurable such that it can place westbound add port 418 in optical communication with a at least one of a second set of output ports 424 including either a western drop port 426 or a eastbound transmit port 428. Second ganged optical switching element 422 is also configurable such that it can place western receive port 420 in optical communication with at least one of a second set of output ports 424 including either western drop port 426 or eastbound transmit port 422. The ganged optical switch's ganging relationship 430 between the second ganged optical switch's first and second ganged optical switching elements, 408 and 422 respectively, is represented by a dashed line.

Although the exemplary node-ganging ROADM system illustrated in FIG. 9 was described as having a non-overlapping GOS with two logically tied ganged switching elements, it will be appreciated by those of skill in the art that node-ganging ROADM system embodiments can be constructed using overlapping GOSs and/or GOSs with single (e.g. physically tied) switching elements. It should also be appreciated that the switching element(s) can be either wavelength-selective or broadband.

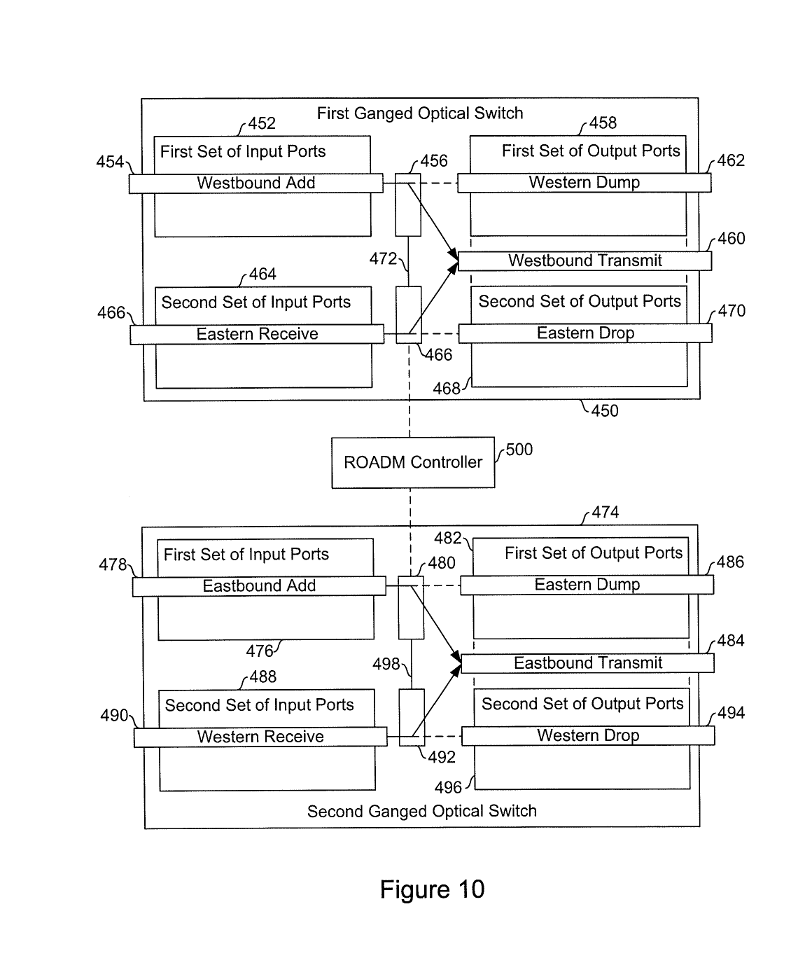

FIG. 10 is a block diagram illustrating a flow-ganging ROADM system constructed using two GOS modules according to an embodiment of the present invention. As used herein, the term flow-ganging means that flow direction of the ROADM (e.g. east to west) is a single GOS. An exemplary flow-ganging ROADM system comprises a first overlapping ganged optical switch 450 a second overlapping ganged optical switch 474, and can optionally include a ROADM controller 500 for ganging the two ganged optical switches 450 and 474.

First overlapping ganged optical switch 450 comprises a first overlapping ganged optical switch's first set of input ports 452, including a westbound add port 454. Westbound add port 454 is in optical communication with the first overlapping ganged optical switch's first ganged optical switching element 456. Via the first overlapping ganged optical switch's first ganged optical switching element 456, westbound add port 454 can be placed in optical communication with either a first overlapping ganged optical switch's first set of output ports 458 including westbound transmit port 460 or a western dump port 462. As used herein, the term dump is used in the sense that optical signals transmitted to the dump port may be used in a number of optional ways, such as for optical performance monitoring, but the actual way in which the optical signal is used is not essential to the working of the present invention. It should be appreciated that the westbound transmit port 460 is an overlapping port in the sense that it is accessible to both the first overlapping ganged optical switch's first set of input ports 452 and the first overlapping ganged optical switch's second set of input ports 464.

First overlapping ganged optical switch 450 further comprises a first overlapping ganged optical switch's second set of input ports 464, including a eastern receive port 466. The eastern receive port 466 is in optical communication with the first overlapping ganged optical switch's second ganged optical switching element 466. Via the first overlapping ganged optical switch's second ganged optical switching element 466, the eastern receive port 466 can be placed in optical communication with either at least one of the first overlapping ganged optical switch's first set of output ports 458 (which also includes at least one of the first overlapping ganged optical switch's second set of output ports 468), including westbound transmit port 460 or at least one of the first overlapping ganged optical switch's second set of output ports 468, including eastern drop port 470. The first overlapping ganged optical switch's ganging relationship 472 between the first overlapping ganged optical switch's first and second ganged optical switching elements, 456 and 466 respectively, is represented by a dashed line.

Second overlapping ganged optical switch 474 comprises a second overlapping ganged optical switch's first set of input ports 476, including a eastbound add port 478. Eastbound add port 478 is in optical communication with the second overlapping ganged optical switch's first ganged optical switching element 480. Via the second overlapping ganged optical switch's first ganged optical switching element 480, eastbound add port 478 can be placed in optical communication with either a second overlapping ganged optical switch's first set of output ports 482 including eastbound transmit port 484 or eastern dump port 486. The eastern dump port 486 can optionally be connected to any other component that can make use of signals from the eastbound add port 478. It should be appreciated that the eastbound transmit port 484 is an overlapping port in the sense that it is accessible to both the second overlapping ganged optical switch's first set of input ports 476 and the second overlapping ganged optical switch's second set of input ports 488.

Second overlapping ganged optical switch 474 further comprises a second overlapping ganged optical switch's second set of input ports 488, including a western receive port 490. The western receive port 490 is in optical communication with the second overlapping ganged optical switch's second ganged optical switching element 492. Via the second overlapping ganged optical switch's second ganged optical switching element 492, the western receive port 490 can be placed in optical communication with either at least one of the second overlapping ganged optical switch's first set of output ports 482 (which also includes at least one of the first overlapping ganged optical switch's second set of output ports 496), including eastbound transmit port 484 or at least one of the second overlapping ganged optical switch's second set of output ports 496, including western drop port 494. The second overlapping ganged optical switch's ganging relationship 498 between the second overlapping ganged optical switch's first and second ganged optical switching elements, 480 and 492 respectively, is represented by a dashed line.

Optional ROADM controller 500 can be used to simultaneously control the first overlapping ganged optical switch's ganging relationship 472 and the second overlapping ganged optical switch's ganging relationship 498. The ROADM controller thereby meta-gangs all four ganged optical switching elements 456, 466, 480, and 492. Indeed the concept can be generalized to any number of ganged optical switches, which can then be meta-ganged into large ROADM networks.

The ROADM controller 500 can enter an add/drop ROADM state, which configures the ganged optical switching elements 456, 466, 480, and 492 such that optical communication between the input and output ports of both overlapping ganged optical switches corresponds to the pairings listed in Table 3.

TABLE 3
Add/Drop ROADM State for FIG. 10

| Input port | Output Port |
|---|---|
| Westbound Add 454 | Westbound Transmit 460 |
| Eastbound Add 478 | Eastbound Transmit 484 |
| Western receive 490 | Western drop 494 |
| Eastern receive 466 | Eastern drop 470 |

The ROADM controller 500 can enter an express ROADM state, which configures the ganged optical switching elements 456, 466, 480, and 492 such that optical communication between the input and output ports of both overlapping ganged optical switches corresponds to the pairings listed in Table 4.

TABLE 4
Express ROADM State for FIG. 10

| Input port | Output Port |
|---|---|
| Westbound Add 454 | Western Dump 462 |
| Eastbound Add 478 | Eastern Dump 486 |
| Western receive 490 | Westbound Transmit 460 |
| Eastern receive 466 | Eastbound Transmit 484 |

Although the exemplary flow-ganging ROADM system illustrated in FIG. 10 was described as having two logically tied ganged switching elements, it will be appreciated by those of skill in the art that flow-ganging ROADM system embodiments can be constructed using GOSs with a single (e.g. physically tied) switching element. It should also be appreciated that the switching elements can be either wavelength-selective or broadband. Other possible embodiments of the exemplary flow-ganging ROADM system illustrated in FIG. 10 can be constructed where only one half of the flow-ganging ROADM is constructed using a GOS, and the other half is constructed using prior art WSS modules or a broadcast and select architecture.

FIG. 11 is a block diagram illustrating a mux/demux-ganging ROADM system constructed using two GOS modules according to an embodiment of the present invention. As used herein, the term mux/demux-ganging means that the mux functions of the ROADM (e.g. adding signals) are controlled by a single GOS, and the demux functions of the ROADM (e.g. dropping signals) are controlled by a single GOS. An exemplary mux/demux-ganging ROADM system comprises a non-overlapping first ganged optical switch 550 and a multicasting and non-overlapping second ganged optical switch 552, and can optionally include a ROADM controller 554 for ganging the two ganged optical switches 550 and 552.

Although a distinction is made for the purposes of the exemplary embodiment of FIG. 11, it should be appreciated that both multicasting and non-multicasting switching elements can be used to construct both sides of a mux/demux-ganging ROADM (i.e. GOSs 550 and 552 can be either of the multicasting or non-multicasting type). However, it should also be noted that it is advantageous to use a multicasting GOS (such as the exemplary multicasting GOS described with reference to FIG. 5, above) for the construction of the demux-ganging side of a mux/demux-ganging ROADM, and a non-multicasting GOS for the construction of the mux-ganging side of a mux/demux-ganging ROADM. This is because, as will become apparent upon reading the following description, that multicasting both add and express-in signals can generate undesirable interference on the mux-ganging side, whereas multicasting drop and express-out signals does not (and can even be highly desirable in what is known in the art as a “drop and continue” network).

First ganged optical switch 550 comprises a first ganged optical switch's first set of input ports 556, including eastbound express-in port 558 and eastbound add port 560. The first ganged optical switch 550 can be referred to for the sake of convenience as the mux-ganging side of the overall ROADM of FIG. 11. Eastbound express-in port 558 and eastbound add port 560 are in optical communication with the first ganged optical switch's first ganged optical switching element 562. Via the first ganged optical switch's first ganged optical switching element 562, either of eastbound express-in port 558 and eastbound add port 560 can be placed in optical communication with a first ganged optical switch's first set of output ports 564 including eastbound transmit port 566. First ganged optical switch 550 further comprises a first ganged optical switch's second set of input ports 568, including westbound express-in port 570 and westbound add port 572. Westbound express-in port 570 and westbound add port 572 are in optical communication with the first ganged optical switch's second ganged optical switching element 574. Via the first ganged optical switch's second ganged optical switching element 574, either of westbound express-in port 570 and westbound add port 572 can be placed in optical communication with a first ganged optical switch's second set of output ports 576 including westbound transmit port 578. The first ganged optical switch's ganging relationship 580 between the first ganged optical switch's first and second ganged optical switching elements, 562 and 580 respectively, is represented by a dashed line.

Second ganged optical switch 552 comprises a second ganged optical switch's first set of input ports 582, including eastern receive port 584. The second ganged optical switch 552 can be referred to for the sake of convenience as the demux-ganging side of the overall ROADM of FIG. 11.Eastern receive port 584 is in optical communication with the second ganged optical switch's first ganged optical switching element 586. Via the second ganged optical switch's first ganged optical switching element 586, the eastern receive port 584 can be placed in optical communication with any of a second ganged optical switch's first set of output ports 588 including eastern drop port 590 and eastern express-out port 592. Second ganged optical switch 550 further comprises a second ganged optical switch's second set of input ports 594, including western receive port 596. Western receive port 596 is in optical communication with the second ganged optical switch's second ganged optical switching element 598. Via the second ganged optical switch's second ganged optical switching element 598, the western receive port 596 can be placed in optical communication with any of a second ganged optical switch's second set of output ports 600 including western drop port 602 and western express-out port 604. The second ganged optical switch's ganging relationship 606 between the second ganged optical switch's first and second ganged optical switching elements, 586 and 598 respectively, is represented by a dashed line. The westbound express-in and eastern express-out ports are in optical communication with each other, and the eastbound express-in and western express-out ports are in optical communication with each other.

Optional ROADM controller 554 can be used to simultaneously control the first ganged optical switch's ganging relationship 580 and the second ganged optical switch's ganging relationship 606. The ROADM controller thereby meta-gangs all four ganged optical switching elements 562, 574, 586, and 598. Indeed, the concept can be generalized to any number of ganged optical switches, which can then be meta-ganged into large ROADM networks.

The ROADM controller 554 can enter an add/drop ROADM state, which configures the ganged optical switching elements 562, 574, 586, and 598 such that optical communication between the input and output ports of both ganged optical switches corresponds to the pairings listed in Table 5.

TABLE 5
Add/Drop ROADM State for FIG. 11

| Input port | Output Port |
|---|---|
| Westbound Add 572 | Westbound Transmit 578 |
| Eastbound Add 560 | Eastbound Transmit 566 |
| Western receive 596 | Western drop 602 |
| Eastern receive 584 | Eastern drop 590 |

The ROADM controller 554 can enter an express ROADM state, which configures the ganged optical switching elements 562, 574, 586, and 598 such that optical communication between the input and output ports of both ganged optical switches corresponds to the pairings listed in Table 6.

TABLE 6
Express ROADM State for FIG. 11

| Input port | Output Port |
|---|---|
| Westbound Express-In 570 | Westbound Transmit 578 |
| Eastbound Express-In 558 | Eastbound Transmit 566 |
| Western receive 596 | Western express-Out 604 |
| Eastern receive 584 | Eastern express-out 592 |

Although the exemplary mux/demux-ganging ROADM system illustrated in FIG. 11 was described as having non-overlapping GOSs with two logically tied ganged switching elements, it will be appreciated by those of skill in the art that side-ganging ROADM system embodiments can be constructed using overlapping GOSs and/or GOSs with single (e.g. physically tied) switching elements. It should also be appreciated that the switching elements can be either wavelength-selective or broadband. Other possible embodiments of the exemplary mux/demux-ganging ROADM system illustrated in FIG. 11 can be constructed where only one half of the mux/demux-ganging ROADM is constructed using a GOS, and the other half is constructed using prior art WSS modules or a broadcast and select architecture. For example, the demux-ganging side of a mux/demux-ganging ROADM can be constructed using a multicasting GOS, whereas the mux-ganging side could be constructed using WSS modules.

In the foregoing description of the various exemplary ROADM architectures constructed using GOSs and illustrated in FIGS. 8-11, only one add and one drop port was illustrated per direction. This limited number of add ports and drop ports was chosen for the sake of simplicity, and it should be appreciated that any number of add ports and drop ports can be used in either direction in a direct attach situation. For example, the ROADM system of FIG. 8, if constructed using wavelength-selective switching elements, and if provided with N add and N drop ports for each direction, corresponds to the exemplary embodiment of the present invention illustrated in FIG. 6. Of course, it is also possible to construct embodiments of the ROADMS disclosed herein where single add and drop ports can be attached to tunable multiplexing filters and demultiplexing filters, respectively, to provide a tunable ROADM system, or to construct embodiments of the ROADMS disclosed herein where single add and drop ports can be attached to passive multiplexing filters and passive demultiplexing filters, respectively. An additional improvement that could be made to any of the ROADMs disclosed herein would be to attach an optical performance monitoring (OPM) module to any drop port.

In the preceding description, the optical switching elements employed in the construction of GOSs and ROADMs according to embodiments of the present invention were described in general terms. However, it should be appreciated that a number of different switching element technologies can be used in embodiments of the present invention to implement a GOS. Exemplary technologies include: tilting reflective switching elements, diffractive steering switching elements, Mach Zehnder switching elements, polarization-rotation switching elements, or planar light guide switching elements. It should also be appreciated that when ganged optical switches are constructed wherein the first and second ganged optical switching elements are a single optical switching element, some of these technologies may require that optical circulators be used as a means of connecting the input and output ports of the ganged optical switch with the single optical switching element.

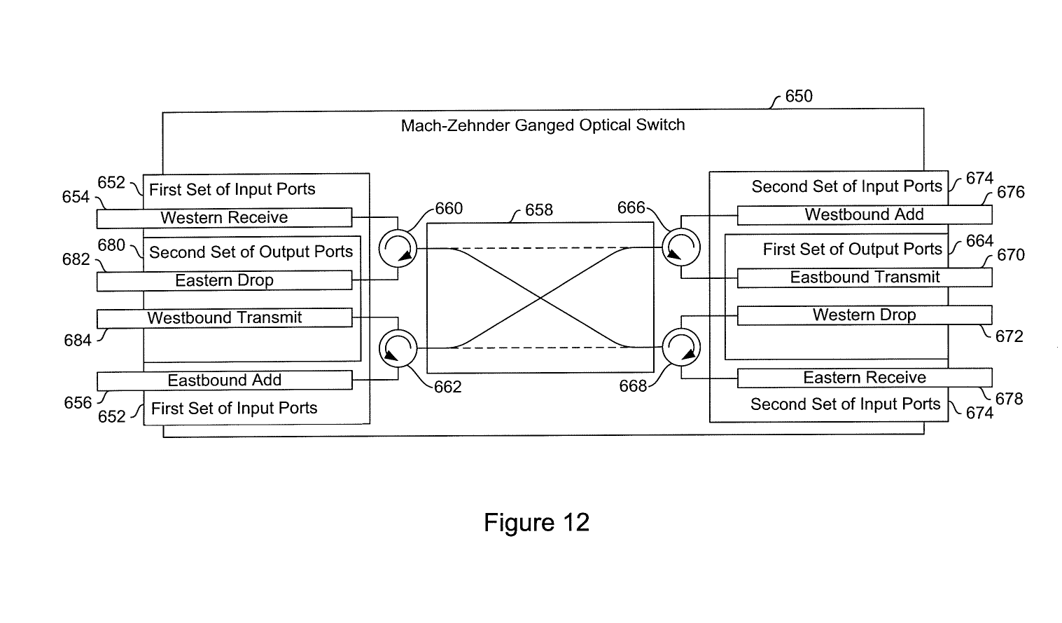

FIG. 12 is a block diagram illustrating a ganged optical switch using optical circulators and a single Mach-Zehnder optical switching element according to an embodiment of the present invention. Mach-Zehnder ganged optical switch 650 has a first set of input ports 652 including a western receive port 654 and a eastbound add port 656. The western receive port 654 is in optical communication with a Mach-Zehnder optical switching element 658 via first optical circulator 660. The eastbound add port 656 is in optical communication with a Mach-Zehnder optical switching element 658 via second optical circulator 662. The Mach-Zehnder ganged optical switch 650 also has a second set of input ports 674 including a westbound add port 676 and a western receive port 678. The westbound add port 676 is in optical communication with Mach-Zehnder optical switching element 658 via third optical circulator 666. The eastern receive port 678 is in optical communication with Mach-Zehnder optical switching element 658 via fourth optical circulator 668.

The Mach-Zehnder optical switching element 658 can optionally place signals received from first optical circulator 660 or second optical circulator 662 in optical communication with either third optical circulator 666 or fourth optical circulator 668, and vice-versa. Third optical circulator 666 and fourth optical circulator 668 are in optical communication with a first set of output ports 664, including a eastbound transmit port 670 and a western drop port 672. First optical circulator 660 and second optical circulator 662 are in optical communication with a second set of output ports 680, including a eastbound transmit port 670 and a western drop port 672. The Mach-Zehnder optical switching element 658 can enter an express state which connects first and third optical circulators 660 and 666, and second and fourth optical circulators 662 and 668. The Mach-Zehnder optical switching element 658 can also enter an add/drop state which connects the first optical circulator 660 to the fourth optical circulator 668, and which connects the second optical circulator 662 to the third optical circulator 666. The first switch state gives rise to the state table at Table 7, while the second switch state gives rise to the state table at Table 8.

TABLE 7
Express ROADM State for FIG. 12

| Input port | Output Port |
|---|---|
| Western receive 654 | Eastbound Transmit 670 |
| Eastbound Add 656 | Western drop 672 |
| Westbound Add 676 | Eastern drop 682 |
| Eastern receive 678 | Westbound Transmit 684 |

TABLE 8
Add/Drop ROADM State for FIG. 12

| Input port | Output Port |
|---|---|
| Western receive 654 | Western drop 672 |
| Eastbound Add 656 | Eastbound Transmit 670 |
| Westbound Add 676 | Westbound Transmit 684 |
| Eastern receive 678 | Eastern drop 682 |

Although the exemplary Mach-Zehnder-based GOS described with reference to FIG. 12 is described as a non-overlapping GOS, it should be appreciated that overlapping GOSs can also be constructed using Mach-Zehnder switching elements. For example, an overlapping GOS can be constructed by re-arranging the allocation of ports shown in FIG. 12 between the different sets of input and output ports, such that some input ports belonging to the first set of input ports can be placed in communication with some output ports from the second set of output ports, and vice-versa. Further, more than one ganged Mach-Zehnder switching element can be used when GOSs are constructed using Mach-Zehnder switching elements, in which case the circulators are not necessary, although they can be used to increase the effective port count of the overall GOS.

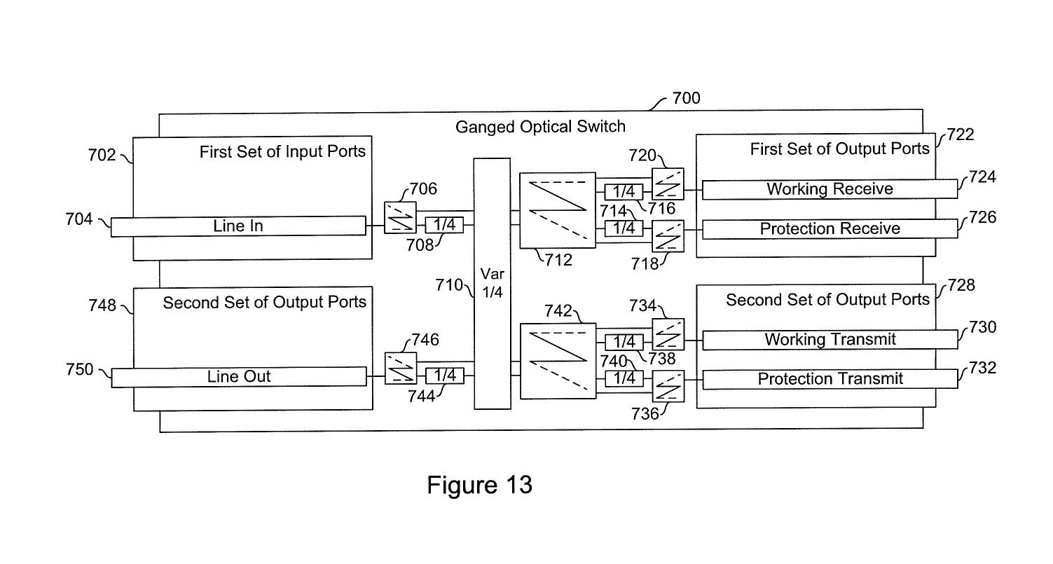

As will be apparent to those of skill in the art, embodiments of the GOS have numerous other applications other than the construction of ROADMs. For example, in one embodiment, a protection switching scheme can be easily constructed using GOS switching elements, as illustrated in FIG. 13. A non-overlapping ganged optical switch 700 has a first set of input ports 702 including a line in port 704. The line in port 704 is in optical communication, via walk-off crystal 706 and ¼ rotator 708, with a variable ¼ polarization rotator 710, which serves as the single ganged optical switching element of non-overlapping ganged optical switch 700. Signals from 1/4 rotator 708 can be passed through variable ¼ polarization rotator 710 to walk-off crystal 712, which transmits the signal to either ¼ rotator 714 or ¼ rotator 716, depending on the polarization that was imparted to the signal by variable ¼ polarization rotator 710. ¼ rotator 714 is in optical communication with walk-off crystal 718, and ¼ rotator 716 is in optical communication with walk-off crystal 720. A first set of output ports 722 includes a working receive port 724 in optical communication with walk-off crystal 720 and working receive port 726 in optical communication with walk-off crystal 726. Thus, line in port 704 can be placed in optical communication with either the working receive port 724 in a working switch state of the variable ¼ polarization rotator 710, and protection receive port 726 in a protection switch state of the variable ¼ polarization rotator 710.

Non-overlapping ganged optical switch 700 also has a second set of input ports 728 including a working transmit port 730 and a protection transmit port 732. The working transmit port 730 is in optical communication, via walk-off crystal 734 and ¼ rotator 738, with walk-off crystal 742. The protection transmit port 732 is in optical communication, via walk-off crystal 734 and ¼ rotator 738, with walk-off crystal 742. Signals from walk-off crystal 742 can be passed through variable ¼ polarization rotator 710 to a second set of output ports 748 including line out port 750 via a further ¼ rotator 744 and/or walk-off crystal 746. As with the first set of input ports 702 and first set of output ports 722 described above, either of working transmit port 730 or protection transmit port 732 can be placed in optical communication with line out port 750, depending on the switch state of variable ¼ polarization rotator 710. Working transmit port 730 can be placed in optical communication with line out port 750 when variable ¼ polarization rotator 710 is in a working state, and protection transmit port 732 can be placed in optical communication with line out port 750 when variable ¼ polarization rotator 710 is in a protection state.

Polarization-rotation based GOSs such as the non-overlapping ganged optical switch 700 shown in FIG. 13 can be used in other GOS applications. For example, two non-overlapping ganged optical switches 700 can be used, with suitable re-naming of ports, to construct a ROADM embodiment such as the exemplary ROADM illustrated in FIG. 8.

Another application of the GOS concept is an optical roundabout switch, such as the optical roundabout switch described in U.S. application Ser. No. ______ (Attorney Docket No.: PAT 5203-2) entitled “Optical Roundabout Switch” and filed of even date herewith, which is incorporated herein by reference in its entirety.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known optical systems are shown in block diagram form in order not to obscure the invention. For example, specific details are not provided as to whether the embodiments of the invention described herein are implemented as a software routine, hardware circuit, firmware, or a combination thereof.

Embodiments of the invention can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention can also be stored on the machine-readable medium. Software running from the machine-readable medium can interface with circuitry to perform the described tasks.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A ganged optical switch comprising:
at least one wavelength selective ganged optical switching element having at least two possible states;
a first set of input ports and a first set of output ports, said at least one wavelength selective ganged optical switching element determining a first routing of optical signals between at least one input port of the first set of input ports and at least one output port of the first set of output ports; and
a second set of input ports and a second set of output ports, said at least one wavelength selective ganged optical switching element determining a second routing of optical signals between at least one input port of the second set of input ports and at least one output port of the second set of output ports; and
said at least one wavelength selective ganged optical switching element tying said first routing and second routing such that a change of state of the at least one wavelength selective ganged optical switching element state produces a change in both said first and second routings.

2. The ganged optical switch of claim 1 wherein at least one of the sets of input ports and output ports includes a plurality of ports.

3. The ganged optical switch of claim 1 wherein at least one of said output ports is a member of the first set of output ports and a member of the second set of output ports.

4. The ganged optical switch of claim 1 wherein no output port in the first set of output ports is a member of the second set of output ports.

5. The ganged optical switch of claim 1 wherein at least one port is in optical communication with the at least one wavelength selective ganged optical switching element via an optical circulator.

6. The ganged optical switch of claim 1 further comprising a passive multiplexing filter in optical communication with at least one member of the first set of input ports and/or the second set of input ports.

7. The ganged optical switch of claim 1 further comprising a tunable multiplexing filter in optical communication with at least one member of the first set of input ports and/or the second set of input ports.

8. The ganged optical switch of claim 1 further comprising a passive demultiplexing filter in optical communication with at least one member of the first set of output ports and/or the second set of output ports.

9. The ganged optical switch of claim 1 further comprising a tunable demultiplexing filter in optical communication with at least one member of the first set of output ports and/or the second set of output ports.

10. The ROADM of claim 1 further comprising an optical performance monitoring module in optical communication with at least one member of the first set of output ports and/or the second set of output ports.

11. A ROADM comprising:
a first ganged optical switch comprising:
a first ganged optical switch's at least one wavelength selective wavelength selective ganged optical switching element having at least two possible states;
a first ganged optical switch's first set of input ports and a first ganged optical switch's first set of output ports, said first ganged optical switch's at least one ganged optical switching element determining a first ganged optical switch's first routing of optical signals between at least one input port of the first ganged optical switch's first set of input ports and at least one output port of the first ganged optical switch's first set of output ports; and
a first ganged optical switch's second set of input ports and a first ganged optical switch's second set of output ports, said second ganged optical switch's at least one wavelength selective ganged optical switching element determining a first ganged optical switch's second routing of optical signals between at least one input port of the first ganged optical switch's second set of input ports and at least one output port of the first ganged optical switch's second set of output ports; and
said first ganged optical switch's at least one wavelength selective ganged optical switching element tying said first ganged optical switch's first routing and said first ganged optical switch's second routing such that a change of state of the first ganged optical switch's at least one ganged optical switching element state produces a change in both said first ganged optical switch's first routing and said first ganged optical switch's second routing.

12. The ROADM of claim 11, further comprising:
a second ganged optical switch comprising:
a second ganged optical switch's at least one wavelength selective ganged optical switching element having at least two possible states;
a second ganged optical switch's first set of input ports and a second ganged optical switch's first set of output ports, said second ganged optical switch's at least one ganged optical switching element determining a second ganged optical switch's first routing of optical signals between at least one input port of the second ganged optical switch's first set of input ports and at least one output port of the second ganged optical switch's first set of output ports; and
a second ganged optical switch's second set of input ports and a second ganged optical switch's second set of output ports, said second ganged optical switch's at least one wavelength selective ganged optical switching element determining a second ganged optical switch's second routing of optical signals between at least one input port of the second ganged optical switch's second set of input ports and at least one output port of the second ganged optical switch's second set of output ports; and
said second ganged optical switch's at least one wavelength selective ganged optical switching element tying said second ganged optical switch's first routing and second ganged optical switch's second routing such that a change of state of the second ganged optical switch's at least one ganged optical switching element state produces a change in both said second ganged optical switch's first routing and second ganged optical switch's second routing.

13. The ROADM of claim 12 further comprising:
a first optical waveguide connecting a first direction express-out port of the of the first ganged optical switch's second set of output ports with a second direction express-in port of the second ganged optical switch's first set of input ports; and
a second optical waveguide connecting a second direction express-out port of the second ganged optical switch's second set of output ports with a first direction express-in port of the first ganged optical switch's first set of input ports; and
a ROADM controller for controlling the wavelength selective ganged optical switching elements of each of the first and second ganged optical switches;
wherein the first ganged optical switch's first set of input ports also includes a first direction add port, the first ganged optical switch's first set of output ports includes a first direction transmit port, the first ganged optical switch's second set of input ports includes a first direction receive port, and the first ganged optical switch's second set of output ports also includes a first direction drop port;
wherein the second ganged optical switch's first set of input ports also includes a second direction add port, the second ganged optical switch's first set of output ports also includes a second direction transmit port, the second ganged optical switch's second set of input ports includes a second direction receive port, and the second ganged optical switch's second set of output ports also includes a second direction drop port.
wherein the ROADM controller has an add/drop ROADM state wherein the ROADM controller causes the at least one wavelength selective ganged optical switching element of the first ganged optical switch to place the first direction add port in optical communication with the first direction transmit port and the second direction receive port in optical communication with the second direction drop port, and wherein the ROADM controller causes the at least one wavelength selective ganged optical switching element of the second ganged optical switch to place the second direction add port in optical communication with the second direction transmit port and the first direction receive port in optical communication with the first direction drop port; and
wherein the ROADM controller has an express ROADM state wherein the ROADM controller causes the at least one wavelength selective ganged optical switching element of the first ganged optical switch to place the first direction express-in port in optical communication with the first direction transmit port and the first direction receive port in optical communication with the first direction express-out port, and wherein the ROADM controller causes the at least one wavelength selective ganged optical switching element of the second ganged optical switch to place the second direction express-in port in optical communication with the second direction transmit port and to place the second direction receive port in optical communication with the second direction express-out port.

14. The ROADM of claim 11 wherein:
the first ganged optical switch's first set of input ports includes a first direction add port and a second direction receive port, the first ganged optical switch's first set of output ports includes a second direction drop port and a first direction transmit port, the first ganged optical switch's second set of input ports includes a second direction add port and a first direction receive port, and the first ganged optical switch's second set of output ports includes a second direction transmit port and a first direction drop port;
the first ganged optical switch's at least one wavelength selective ganged optical switching element has an add/drop ROADM state which places the first direction add port in optical communication with the first direction transmit port, the first direction receive port in optical communication with the first direction drop port, the second direction add port in optical communication with the second direction transmit port, and the second direction receive port in optical communication with the second direction drop port; and
the first ganged optical switch's at least one wavelength selective ganged optical switching element has an express ROADM state which places the first direction receive port in optical communication with the second direction transmit port, and the second direction receive port in optical communication with the first direction transmit port.

15. The ROADM of claim 12 further comprising:
a ROADM controller for controlling the at least one wavelength selective ganged optical switching element of each of the first and second ganged optical switches;
wherein one of the first ganged optical switch's first set of input ports is a first direction add port, one of the first ganged optical switch's second set of input ports is a second direction receive port, one of the first ganged optical switch's first set of output ports is a first direction dump port, one of the first ganged optical switch's second set of output ports is a second direction drop port, and a first direction transmit port belongs to both the first ganged optical switch's first set of outputs and the first ganged optical switch's second set of outputs;
wherein one of the second ganged optical switch's first set of input ports is a second direction add port, one of the second ganged optical switch's second set of input ports is a first direction receive port, one of the second ganged optical switch's first set of output ports is a second direction transmit port, one of the second ganged optical switch's second set of output ports is a first direction drop port, and a second direction transmit port belongs to both the second ganged optical switch's first set of outputs and the second ganged optical switch's second set of outputs;
wherein the ROADM controller can enter an add/drop ROADM state wherein the ROADM controller causes the at least one wavelength selective ganged optical switching element of the first ganged optical switch to place the first direction add port in optical communication with the first direction transmit port and the second direction receive port in optical communication with the second direction drop port, and wherein the ROADM controller causes the at least one wavelength selective ganged optical switching element of the second ganged optical switch to place the second direction add port in optical communication with the second direction transmit port and the first direction receive port in optical communication with the first direction drop port; and
wherein the ROADM controller can enter an express ROADM state wherein the ROADM controller causes the at least one wavelength selective ganged optical switching element of the first ganged optical switch to place the first direction add port in optical communication with the first direction dump port and the second direction receive port in optical communication with the first direction transmit port, and wherein the ROADM controller causes the at least one wavelength selective ganged optical switching element of the second ganged optical switch to place the second direction add port in optical communication with the second direction dump port and to place the first direction receive port in optical communication with the second direction transmit port.

16. The ROADM of claim 11 wherein the first ganged optical switch's first set of input ports includes a second direction express-in port and a second direction add port, the first ganged optical switch's first set of output ports includes a second direction transmit port, the first ganged optical switch's second set of input ports includes a first direction express-in port and a first direction add port and the first ganged optical switch's second set of output ports includes a first direction transmit port.

17. The ROADM of claim 11 wherein the first ganged optical switch's first set of input ports includes a second direction receive port, the first ganged optical switch's first set of output ports includes a second direction drop port and a second direction express-out, the first ganged optical switch's second set of input ports includes a first direction receive port, the first ganged optical switch's second set of output ports includes a first direction drop port and a first direction express-out port, and wherein the first ganged optical switch is a multiplexing ganged optical switch.

18. The ROADM of claim 12 further comprising:
a first optical waveguide connecting a first direction express-out port of the of the second ganged optical switch's second set of output ports with a second direction express-in port of the first ganged optical switch's first set of input ports;
a second optical waveguide connecting a second direction express-out port of the second ganged optical switch's first set of output ports with a first direction express-in port of the first ganged optical switch's second set of input ports; and
a ROADM controller for controlling the wavelength selective ganged optical switching elements of each of the first and second ganged optical switches;
wherein the first ganged optical switch's first set of input ports includes the second direction express-in port and a second direction add port, the first ganged optical switch's first set of output ports includes a second direction transmit port, the first ganged optical switch's first set of input ports includes the first direction express-in port and a first direction add port, and the first ganged optical switch's second set of output ports includes a first direction transmit port;
wherein the second ganged optical switch's first set of input ports includes a second direction receive port, the second ganged optical switch's first set of output ports includes a second direction drop port and the second direction express-out, the second ganged optical switch's second set of input ports includes a first direction receive port, and the second ganged optical switch's second set of output ports includes a first direction drop port and the first direction express-out port;
wherein the ROADM controller can enter an add/drop ROADM state wherein the ROADM controller causes the at least one wavelength selective ganged optical switching element of the first ganged optical switch to place the second direction add port in optical communication with the second direction transmit port and the first direction add port in optical communication with the first direction transmit port, and wherein the ROADM controller causes the at least one wavelength selective ganged optical switching element of the second ganged optical switch to place the second direction receive port in optical communication with the second direction drop port and the first direction receive port in optical communication with the first direction drop port; and
wherein the ROADM controller can enter an express ROADM state wherein the ROADM controller causes the at least one wavelength selective ganged optical switching element of the first ganged optical switch to place the second direction express-in port in optical communication with the second direction transmit port and the first direction express-in port in optical communication with the first direction transmit port, and wherein the ROADM controller causes the at least one wavelength selective ganged optical switching element of the second ganged optical switch to place the second direction receive port in optical communication with the second direction express-out port and to place the first direction receive port in optical communication with the first direction express-out port.

19. The ROADM of claim 12 further comprising:
a first splitter having a first splitter's first direction receive port, a first splitter's first output port and a first splitter's second output port;
a second splitter having a second splitter's second direction receive port, a second splitter's first output port and a second splitter's second output port;
a first optical waveguide connecting the first splitter's first output port with a second direction express-in port of the second ganged optical switch's first set of input ports;
a second optical waveguide connecting the first splitter's second output port with a first direction receive port of the first ganged optical switch's second set of input ports;
a third optical waveguide connecting the second splitter's first output port with a first direction express-in port of the first ganged optical switch's first set of input ports;
a fourth optical waveguide connecting the second splitter's second output port with a second direction receive port of the second ganged optical switch's second set of input ports; and
a ROADM controller for controlling the wavelength selective ganged optical switching elements of each of the first and second ganged optical switches;
wherein the first ganged optical switch's first set of input ports also includes a first direction add port, the first ganged optical switch's first set of output ports includes a first direction transmit port, and the first ganged optical switch's second set of output ports also includes a first direction drop port;
wherein the second ganged optical switch's first set of input ports also includes a second direction add port, the second ganged optical switch's first set of output ports also includes a second direction transmit port, and the second ganged optical switch's second set of output ports also includes a second direction drop port.
wherein the ROADM controller has an add/drop ROADM state wherein the ROADM controller causes the at least one wavelength selective ganged optical switching element of the first ganged optical switch to place the first direction add port in optical communication with the first direction transmit port and the second direction receive port in optical communication with the second direction drop port, and wherein the ROADM controller causes the at least one wavelength selective ganged optical switching element of the second ganged optical switch to place the second direction add port in optical communication with the second direction transmit port and the first direction receive port in optical communication with the first direction drop port; and
wherein the ROADM controller has an express ROADM state wherein the ROADM controller causes the at least one wavelength selective ganged optical switching element of the first ganged optical switch to place the first direction express-in port in optical communication with the first direction transmit port, and wherein the ROADM controller causes the at least one wavelength selective ganged optical switching element of the second ganged optical switch to place the second direction express-in port in optical communication with the second direction transmit port.

20. A protection switching element comprising:
a ganged optical switch comprising:
at least one wavelength selective wavelength selective ganged optical switching element having at least two possible states;
a first set of input ports and a first set of output ports, said at least one ganged optical switching element determining a first routing of optical signals between at least one input port of the first set of input ports and at least one output port of the first set of output ports; and
a second set of input ports and a second set of output ports, said at least one wavelength selective ganged optical switching element determining a second routing of optical signals between at least one input port of the second set of input ports and at least one output port of the second set of output ports; and
said at least one wavelength selective ganged optical switching element tying said first routing and second routing such that a change of state of the at least one ganged optical switching element state produces a change in both said first and second routings;
wherein the first set of input ports includes a receive port, the first set of output ports includes a protection receive port and a working receive port; the second set of input ports includes a protection transmit port and a working transmit port, and the second set of output ports includes a transmit port.
